(19) United States
(12) Patent Application Publication
(10) Pub. No.: US 2005/0002047 A1
(43) Pub. Date: Jan. 6, 2005

(54) Printer and control method for printer

(75) Inventor: Satoru Ono, Nagano (JP)

Correspondence Address: SUGHRUE MION, PLLC, 2100 PENNSYLVANIA AVENUE, N.W., SUITE 800, WASHINGTON, DC, 20037, US

(73) Assignee: SEIKO EPSON CORPORATION

(21) Appl. No.: 10/831,362

(22) Filed: Apr. 26, 2004

(30) Foreign Application Priority Data
Apr. 24, 2003 (JP) P. 2003-119843

(51) Int. Cl. H04N 1/60

(52) U.S. Cl. 358/1.9; 358/518; 358/521

(57) ABSTRACT

The present invention provides a control method for a printer, the method is utilized when the specific color is printed in a color print. In the method, step S13, when a print instruction J2 is decided to be the information for a printing process, a process advances to step S31 to decide whether or not a data form including color data in the print instruction J2 is present in a data base 203. When a designated color in the data form is black, the decision in the step S31 may be performed on the basis of whether or not both of a value of a* and a value of b* are zero. If the color data is already registered, a one-dimensional color correction is performed in step S32. If it is not, the process advances to step S33 for a color conversion by using an ordinary color engine.

### FIELD OF THE INVENTION

The present invention relates to a printer and more particularly to a technique for correcting a gradation of a single color for each printer.

DESCRIPTION OF THE RELATED ART

In a color printer, a color is reproduced (color generation) in a color space (refer it to as a “printer color space”, hereinafter) determined by inks to be used such as CMYK (cyan, magenta, yellow and black).

As one form of use of the color printer, there is a form, what is called a pre-simulation that before an image to be printed is printed in a mass-production, the printer is used for the purpose of recognizing the state of the color printer as a test.

In order to generate colors without depending on the difference between the color printer and a printer for a mass-production or the difference of printing media, what is called a color management is employed. For instance, data converted into a coordinate of L*a*b* as a device independent color space is used so that the colors generated as printed results respectively in the color printer and the printer for a mass-production are allowed to correspond to each other.

However, in the pre-simulation, not the hue, but only the gradation of a single color may be sometimes satisfactorily recognized. In this case, even in the color printer, one ink (for instance, black) is used to perform a printing operation.

A technique for performing the pre-simulation is disclosed in Patent Document 1 (JP-A-9-186894).

However, since the colors are generated in accordance with a plurality of inks in the color printer, when a single ink is desired to be printed, for instance, even when a black ink is used to be printed, the colors may be possibly generated on the basis of a subtractive color mixture using a cyan ink, a magenta ink and an yellow ink. In the color generation by the subtractive color mixture and the color generation by a monochromatic ink, even when the data converted into the coordinate of L*a*b* as the printer color space is the same, a hue is undesirably different between them. This phenomenon is especially apparent when a gradation is printed.

Further, the above-described problem also arises when a driver for outputting the data converted into the coordinate of the device independent color space to the printer is used.

### SUMMARY OF THE INVENTION

Thus, it is an object of the present invention to provide a technique for employing specific ink of a printer when the specific ink is printed in the color print.

A first invention relates to a control method for a color printer having a plurality of color inks. Color data to be registered that is obtained from a print instruction is paired with the color of ink (designated color) corresponding to the color data to be registered to prepare a data form. Accordingly, the color printer is enabled to previously store that a color is generated by using a specific ink for specific color data.

Especially, a quantity of use of ink corresponding to the designated color is allowed to correspond to the color data to be registered, so that a gradation desired by an operator can be set.

In a second invention, when color data for printing obtained from the print instruction is already registered in the first invention, a one-dimensional color correction is performed for the quantity of use of ink corresponding to the designated color. Accordingly, when specific color is printed, the specific ink of the printer can be used.

Specifically, when the designated color is colorless, if it is decided that the chromaticity of the color data is zero, it is decided that the color data for printing has been already registered. Thus, the one-dimensional color correction can be easily started.

In the first and second inventions, especially when the color data is set in a printer color space independent of a device, a phenomenon that even when the color data is the same, a hue is different depending on the printer can be avoided.

### BRIEF DESCRIPTION OF THE DRAWINGS

FIG. 1 is a block diagram showing a system to which a control method according to the present invention can be applied;

FIG. 2 is a flow chart showing an operation in an embodiment of the present invention;

FIG. 3 is a diagram schematically showing the structure of a print instruction;

FIG. 4 is a flow chart showing the detail of a registering process;

FIG. 5 is a diagram showing an example of a data form; and

FIG. 6 is a flow chart showing the detail of a printing process.

In the drawings, a reference sign J2 refers to a print instruction; J3 to an inquiry of designated color; J4 to a designated value information; J21 to characteristic information; J22 to picture drawing data; and J211 to register information.

### DETAILED DESCRIPTION OF THE PREFERRED EMBODIMENTS

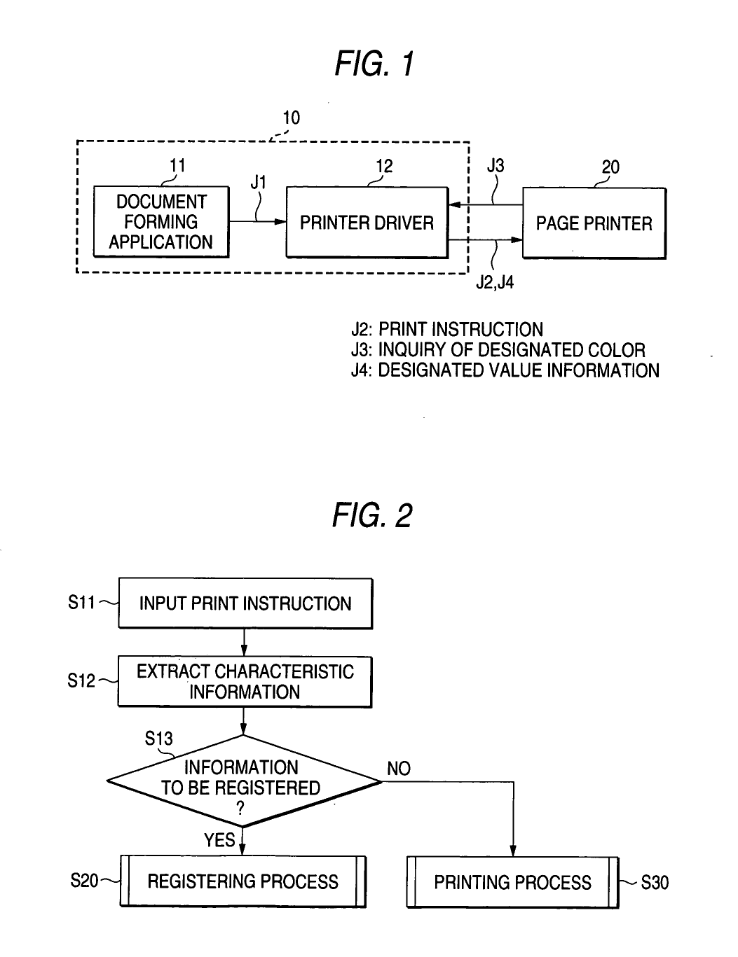

FIG. 1 is a block diagram showing a system to which a control method according to the present invention can be applied. In a computer 10, a document forming application 11 and a printer driver 12 are executed. The document forming application 11 is application software for preparing a document including characters and/or images and outputs document information J1 representing the prepared document.

The printer driver 12 forms a print instruction J2 as an instruction for controlling a printer to print the document in accordance with the document information J1 and outputs the print instruction to the printer, for instance, a page printer 20. The print instruction J2 is prepared by a page description language. The print instruction J2 includes information for setting color such as information for setting color for each pixel or for each character as color data. In order to generate colors without depending on the difference between the color printer and a printer for a mass-production or the difference of printing media as described above, the color data is set in a printer color space independent of a device. As the printer color space independent of the device, for instance, L*a*b* is employed.

FIG. 2 is a flow chart showing an operation in the page printer 20. Firstly, in step S11, the print instruction J2 is inputted. Then, in step S12, characteristic information is extracted. Generally, the page printer 20 has analyzing means for analyzing the page description language. In this means, the characteristic information is extracted.

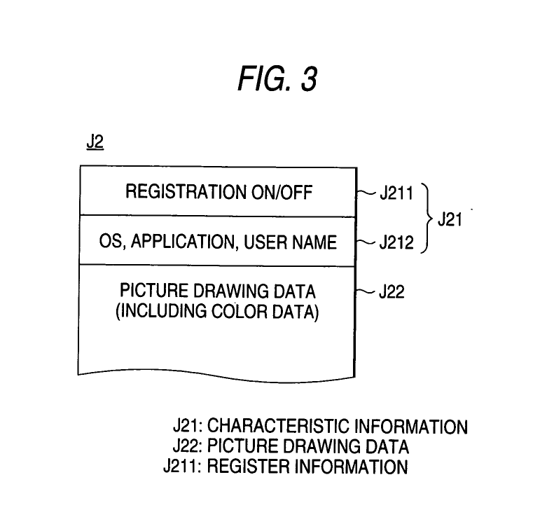

FIG. 3 schematically shows the structure of the print instruction J2. The print instruction J2 has characteristic information J21 as well as picture drawing data J22 for directly specifying the contents of print. The characteristic information J21 includes register information J211 and using information J212. The register information J211 indicates whether the print instruction J2 is information for a registering process or information for a printing process. The register information J211 is respectively described as, for instance “ON” and “OFF” in accordance with whether the print instruction J2 is the information for a registering process or the information for a printing process. This part can be formed as a comment sentence in, for instance, a well-known page description language. The using information J212 indicates, for instance, an operation system (OS) used in the computer 10, the name of the application 11 or the user name of the computer 10.

The picture drawing data J22 has data for identifying objects such as characters or images or color data, etc.

In step S13 shown in FIG. 2, the page printer 20 decides the contents of the register information J211 in the analyzing means ordinarily included therein. When the print instruction J2 indicates the information for the registering process, the page printer advances a process to step S20. When the print instruction J2 indicates the information for the printing process, the page printer advances the process to step S30, respectively.

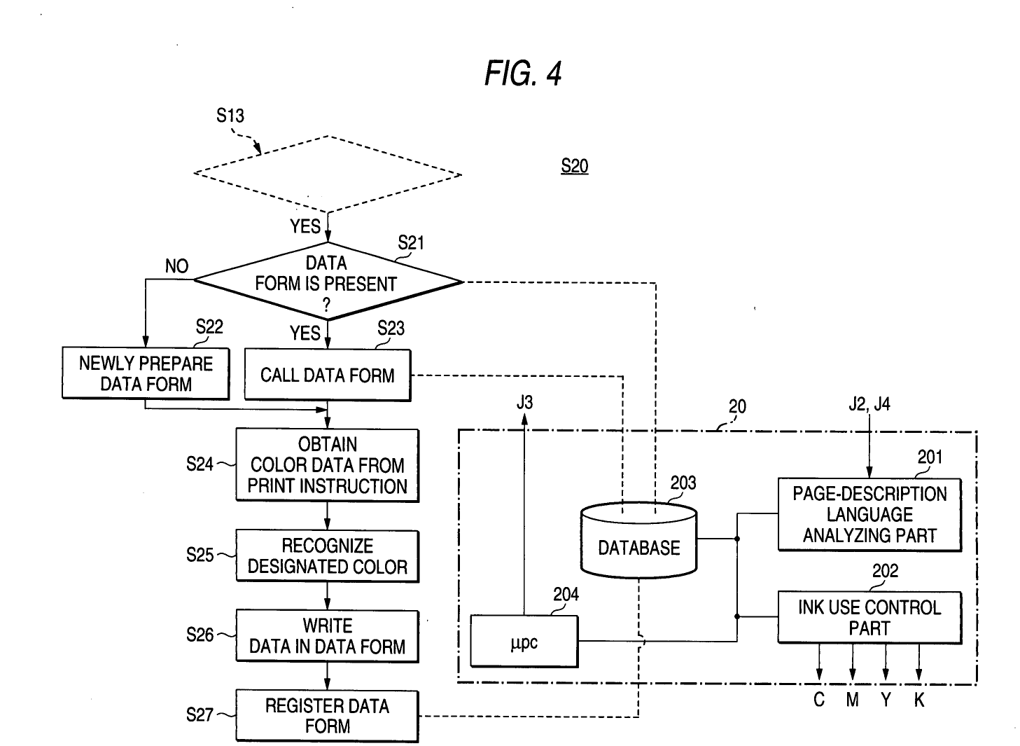

FIG. 4 is a flow chart showing the detail of the registering process S20. The inner structure of the page printer 20 related to the flow chart is also shown.

The page printer 20 includes a page description language analyzing part 201, an ink use control part 202, a data base 203 and a microcomputer (in the drawing, represented by “μpc”) 204. The page description language analyzing part 201 analyzes the print instruction J2 written in the page description language. The ink use control part 202 sets a quantity of use of each of inks of CMYK to discharge the inks to prescribed positions. The data base 203 stores a data form showing the relation between the color of the ink preset by a user and the color data. The microcomputer 204 performs a calculation necessary for the operations of the page description language analyzing part 201, the ink use control part 202 and the data base 203 and controls the operations of them.

Firstly, in step S13, when it is decided that the print instruction J2 is the information for the registering process, the process advances to step S21 to decide whether or not the data form is already present. This decision is carried out by referring to the data base 203 as shown by a broken line. When the data form is not yet formed, the process advances to step S22 to form a new data form. Further, when the data form is already formed, the process advances to step S23 to refer to the data base 203 as shown by a broken line and call the data form. The processes of the steps S21 to S23 can be performed mainly by the microcomputer 204.

After either the step S22 or the step S23 is performed, the color data is obtained from the print instruction J2 in step S24. This process is performed by, for instance, the page description language analyzing part 201. In accordance with this process, the color data represented by the coordinate of L*a*b* is obtained from the picture drawing data J22.

Then, the process advances to step S25 to transmit the inquiry J3 of designated color to the printer driver 12 from the microcomputer 204 of the page printer 20. The inquiry J3 inquires of the printer driver 12 what is the color (refer it to as a “designated color”, hereinafter) of ink used when the color data described in the picture drawing data J22 is allowed to generate color.

An ink for a pre-simulation may be previously determined as a default value in the printer driver 12 or an operator of the computer 10 may be inquired of by performing the printer driver 12.

Specifically, for instance, when a K ink is employed as the ink for the pre-simulation, the value of the L*a*b*=(L0, 0, 0) is described as the color data in the picture drawing data J22 in the print instruction J2 for the registering process (In this case, figures in the parentheses indicate the values of L*, a* and b* in order, the same in the following). Accordingly, the default value in the printer driver 12 is used or the operator makes a setting to determine the use of the K ink. In such a way, the designated color that can be used in the pre-simulation, especially in displaying gradation can be recognized.

At this time, the quantity of use of ink (refer it to as a “designated value”, hereinafter) that is obtained by designating the quantity of use of each ink of CMYK on the basis of 8 bit data is likewise determined. For instance, the designated value is (0,0,0,0) for the L*a*b*=(100, 0,0). The designated value is (0,0,0,127) for the L*a*b*=(50,0,0). The designated value is (0,0,0,255) for the L*a*b*=(0, 0,0) (In this case, the figures of the designated values in the parentheses indicate the quantities of use of C ink, M ink, Y ink and K ink in order: the same in the following). Such designated values are transmitted to the page printer 20 from the computer 10 as designated value information J4.

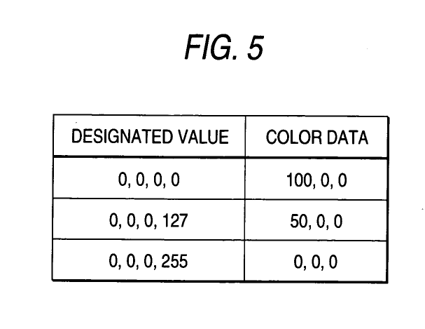

Then, the process advances to step S26 to write the designated value and the color data as a pair in the data form. FIG. 5 shows an example of the data form prepared by using the designated values and the color data as exemplified above. Then, when the data form is completely written, the data form is registered in the data base 203 in step S27.

It is to be understood that the processes of the steps S21, S23 and S24 are sequentially advanced and the designated values and the color data may be added to the existing data form.

As described above, in the step S24, the color data to be registered is obtained from the print instruction J2 to the page printer 20. In the step S25, any one of the CMYK inks corresponding to the color data to be registered is obtained as the designated color. In the step S26, the data form including the color data to be registered and the designated color as a pair is formed. In accordance with these steps, the page printer 20 can previously store that one specific ink is used for the specific color data to generate the color.

Then, in the step S25, the designated value as the quantity of use of ink corresponding to the designated color is allowed to correspond to the color data to be registered, so that the gradation desired by the operator can be set.

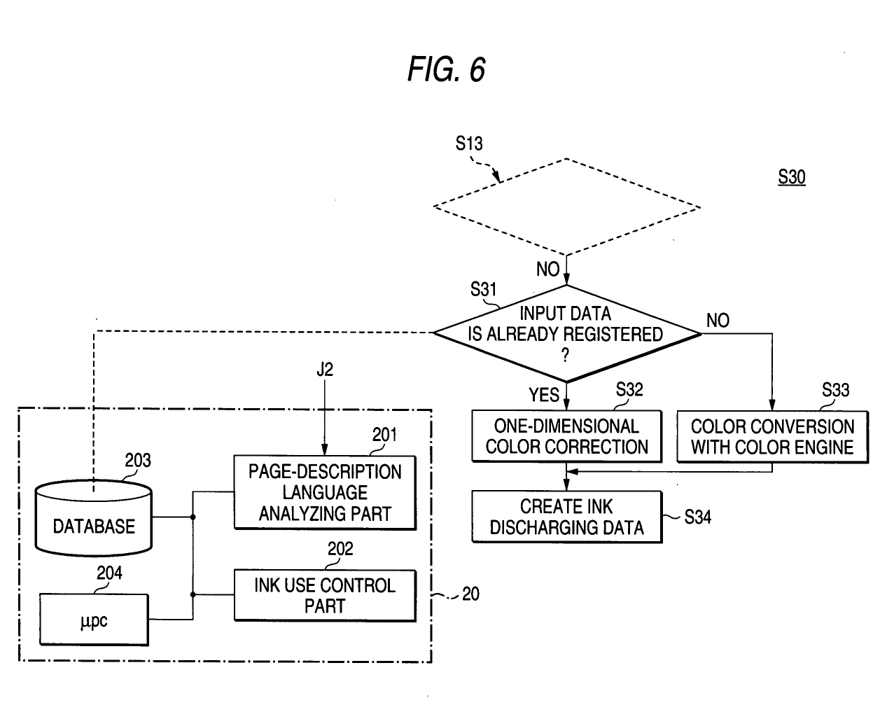

FIG. 6 is a flow chart showing the detail of a printing process S30. FIG. 6 also shows the inner structure of the page printer 20 associated with the flow chart. Firstly, in step S13, when the print instruction J2 is decided to be the information for the printing process, a process advances to step S31 to decide whether or not the data form including the color data in the picture drawing data J22 is present in the data base 203.

For instance, it is assumed that the data form shown in FIG. 5 is already registered in the data base 203. Then, in the picture drawing data J22 of the print instruction J2 as the information for the printing process, when the L*a*b*=(100, 0,0) exists as the color data, the color data is decided to have been already registered. Then, the process advances to step S32 to carry out a one-dimensional color correction. According to the example shown in FIG. 5, the quantity of use of the K ink to L*a*b*=(L0, 0,0) which is further inputted is likewise obtained on the basis of L*a*b*=(100, 0,0), (50,0,0) and (0,0,0) and the designated values (0,0,0,0), (0,0,0,127) and (0,0,0,255) corresponding thereto.

Otherwise, when the designated color is black (a designation that the K ink is employed to generate the color), the decision in the step S31 may be performed on the basis of whether or not both of a value of a* and a value of b* are zero. For instance, when the inputted color data indicates L*a*b*=(L0, 0,0), the color data may be decided to be already registered to perform the one-dimensional color correction in the step S32 so that the quantity of use of the K ink corresponding to L*a*b*=(L0, 0,0) is obtained.

On the other hand, when it is decided that the color data is not already registered, the process advances to step S33 to perform a color conversion using an ordinary color engine.

For instance, it is assumed that the data form shown in FIG. 5 is already registered in the data base 203. Further, it is assumed that L*a*b*=(100, 0,0), (50,0,0) and (0,0,0) are not described in the inputted color data. Otherwise, it is assumed that at least one of the value of a* and the value of b* is not zero.

When the one-dimensional color correction is performed, ink discharging data using only the K ink is formed on the basis thereof. When the color conversion is carried out, ink discharging data for each of inks of CMYK is created on the basis thereof respectively in step S34.

The one-dimensional color correction based on the data form, the color conversion based on the color engine and the formation of the ink discharging data can be performed in the ink use control part 202.

As described above, when the color data for the printing process obtained from the print instruction J2 is already registered, the one-dimensional color correction of the quantity of use of the ink corresponding to the designated color is carried out. Accordingly, when the specific color is printed, the specific ink of the printer can be used.

Specially, when colorless ink such as the K ink is designated, if the value of a* and the value of b* as indexes showing the chromaticity of the color data are zero, the color data for the printing process is decided to be already registered. Thus, the one-dimensional color correction can be readily started.

Finally, the one-dimensional color correction of the ink can be carried out on the basis of the previously registered data form. Accordingly, even when the driver for outputting the data converted into the coordinate of the printer color space independent of the device to the printer is used, the specific ink of the printer can be used upon printing the specific color. Therefore, such a phenomenon can be avoided that even when the color data converted into the coordinate of the printer color space independent of the device is the same, a hue is different depending on the printers.

In the above-described embodiment, a case in which the K ink is used as the designated color is mainly described. However, the present invention may be applied to a case in which the C ink, the M ink or the Y ink is used as the designated color.

For instance, when the C ink is used as the designated color, the designated value is (0,0,0,0) for the L*a*b*=(100, 0,0). The designated value is (128,0,0,0) for the L*a*b*=(75, −50, −50). The designated value is (255, 0, 0,0) for the L*a*b*=(50, −100, −100). In this case, in the step S31, when the value of a* is equal to the value of b* and a value obtained by adding half these values to 100 is equal to the value of L*, the color data can be decided to be already registered.

When the M ink is used as the designated color, the designated value is (0,0,0,0) for the L*a*b*=(100, 0,0). The designated value is (0, 128,0,0) for the L*a*b*=(75, 50, −10). The designated value is (0, 255, 0,0) for the L*a*b*=(50, 100, −20). In this case, in the step S31, when the value of a* is (−5) times as large as the value of b* and a value obtained by subtracting a value 2.5 times as large as the value of b* from 100 is equal to the value of L*, the color data can be decided to be already registered.

When the Y ink is used as the designated color, the designated value is (0,0,0,0) for the L*a*b*=(100, 0,0). The designated value is (0,0,128,0) for the L*a*b*=(75, 0, 50). The designated value is (0, 0, 255,0) for the L*a*b*=(50, 0, 100). In this case, in the step S31, when the value of a* is zero and a value obtained by subtracting half the value of b* from 100 is equal to the value of L*, the color data can be decided to be already registered.

1. A control method for a printer, comprising:
a registering step including:
(a-1) a step of obtaining color data to be registered from a print instruction to a color printer having a plurality of color inks;
(a-2) a step of obtaining a designated color corresponding to the color data to be registered and to any one of the plurality of color inks; and
(a-3) a step of forming a data form including the color data to be registered and the designated color as a pair.

2. The control method according to claim 1,
wherein, in the step (a-2), a quantity of use of the ink corresponding to the designated color is allowed to correspond to the color data.

3. The control method according to claim 1, further comprising:
a printing step including:
(b-1) a step of obtaining color data for printing from the print instruction; and
(b-2) a step of performing a one-dimensional color correction for the quantity of use of the ink corresponding to the designated color when the color data for printing is already registered.

4. The control method according to claim 3, wherein, in the step (b-2), the designated color is colorless and when it is decided that the chromaticity of the color data is zero, it is decided that the color data for printing has been already registered.

5. The control method for a printer according to claim 2, further comprising:
a printing step including:
(b-1) a step of obtaining color data for printing from the print instruction; and
(b-2) a step of performing a one-dimensional color correction for the quantity of use of the ink corresponding to the designated color when the color data for printing is already registered.

6. The control method according to claim 5,
wherein the designated color is colorless and when it is decided that the chromaticity of the color data is zero in the step (b-2), it is decided that the color data for printing has been already registered.

7. The control method according to any one of claims 1 to 6,
wherein the color data is set in a device independent color space.

8. A color printer having a plurality of color inks comprising:
a page-description language analyzer for analyzing a print instruction described with page-description language and extracting color data to be registered form the print instruction;
a microcomputer for obtaining a designated color which corresponds to both of color data in the drawing data and one of the color inks; and
a data base for storing data form in which correspondence of color data to a designation value representing the designated color is written.

9. The color printer according to claim 8,
wherein said microcomputer calculate a quantity of use of the ink corresponding to the designated color with referring to the data form.

10. The color printer according to color 8,
wherein the page-description language analyzer further obtains color data for printing from the print instruction, and
wherein, if the color data for printing is already registered in the data form, the microcomputer performs one-dimensional color correction of the quantity of use of the ink corresponding to the designated color.

11. The color printer according to claim 10,
wherein, if the designated color is colorless and the chromaticity of the color data is zero, the microcomputer determines that the color data for printing is already registered and then performs the one-dimensional color correction.

12. The color printer according to color 9,
wherein the page-description language analyzer further obtains color data for printing from the print instruction, and
wherein, if the color data for printing is already registered in the data form, the microcomputer performs one-dimensional color correction of the quantity of use of the ink corresponding to the designated color.

13. The color printer according to claim 12,
wherein, if the designated color is colorless and the chromaticity of the color data is zero, the microcomputer determines that the color data for printing is already registered and then performs the one-dimensional color correction.

14. The control method according to any one of claims 8 to 13,
wherein the color data is set in a device independent color space.
